(19) United States
(12) Patent Application Publication
(10) Pub. No.: US 2025/0272201 A1
(43) Pub. Date: Aug. 28, 2025

(54) MODIFYING RESTORE SCHEDULES TO MITIGATE SPIKE ACTIVITY DURING DATA RESTORES

(71) Applicant: Dell Products L.P., Round Rock, TX (US)

(72) Inventors: Mahesh Reddy Av, Bangalore (IN); Avinash Kumar, Patna (IN); Terry O'Callaghan, Hopkinton, MA (US)

(21) Appl. No.: 18/590,276

(22) Filed: Feb. 28, 2024

(51) Int. Cl. G06F 11/14

(52) U.S. Cl. CPC G06F 11/1469; G06F 11/1464

(57) ABSTRACT

A policy level controller coordinates a scheduling and policy engine using a data change metric to dynamically schedule or re-define policies in response to data change rates in data assets in a current data restore session. A supervised learning process trains a model using historical data of restore operations of the system to establish past data change metrics for corresponding restore operations processing the saveset, and modifies policies dictating the restore schedule by determining a data change rate of received data, as expressed as a number of bytes changed per unit of time. In response to input from restore targets regarding present usage, it then modifies the restore schedule to minimize the impact on restore targets that may be at or close to overload conditions.

### TECHNICAL FIELD

Embodiments are generally directed to large-scale data protection systems and more specifically to modifying restore schedules to mitigate activity spikes during restores.

### BACKGROUND

Data protection involves backing up data for storage and restoration in case of system failure. Data can be copied or cloned from a data source to a storage target through a backup server. With ever increasing amounts of data and the need for scalability in enterprise level data systems, the data to be backed up and restored can vary widely with regards to backup requirements and preferences. In a typical data protection scenario, a system administrator may define different data protection policies for backup and restore operations, each of which may be suited to a different use case.

Data restoration involves moving backup data from a backup location and restoring it to its original location or a new location. Such operations return data that has been backed up in anticipation or response to a data attack, system failure or other similar event. In large-scale systems, data restores are significant events, and scheduled restores can cause huge performance spikes in high-tier organizations. This is typically due to the scheduling engine lacking the decision-making intelligence whenever the restore activity from multiple hosts are requested at once. For example, different hosts that are isolated may look at the same target device for the restore operations, or, the same host may have requested a restore for a huge data object that has breached an expected restore window. Existing scheduling engines generally do not consider any sort of data change measure to tune itself, but instead work on a purely manual override basis. Due to this, a user may not be able to perform certain policy changes at an asset level for a specific period of time. For example, in a system with many assets of a similar data type, if some assets take longer than usual to restore, these assets could breach a restore window breach and cause a spike on the production host activities. In this case, the user must add another schedule or controller for those assets separately from the other like assets. This increases the management overhead and generates redundant controller information for a policy with similar assets. Ultimately, this could lead to a compromise of recovery time objectives (RTO) due to a spiked performance on the restore host.

What is needed, therefore, is a system and method that can dynamically modify restore schedules to reduce performance spikes in data protection systems.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Data Domain, Data Domain Restorer, and PowerProtect are trademarks of Dell Technologies, Inc.

### BRIEF SUMMARY OF EMBODIMENTS

Embodiments are directed to a data protection system that utilizes certain historical data using data change measures to modify scheduling and policies for restore operations in a data protection system. Such embodiments overcome the issues associated with present policy engines that cannot automatically and seamlessly accommodate changing data loads in data assets during a data restore period, and that require manually overriding or rescheduling restore jobs to prevent overloading data restore targets.

A policy level controller (PLC) coordinates a scheduling and policy engine using a data change metric to dynamically schedule or re-define policies in response to data change rates in data assets in a current data restore session. A supervised learning process trains a model using historical data of restore operations of the system to establish past data change metrics for corresponding restore operations processing the dataset, and modifies policies dictating the restore schedule by determining a data change rate of received data, as expressed as a number of bytes changed per unit of time. In response to input from restore targets regarding present usage, it then modifies the restore schedule to minimize the impact on restore targets that may be at or close to overload conditions.

The PLC is further configured to leverage the historic data from the previous policy/PLC information regarding the assets, time consumed for successful data transfers, bandwidth utilized for calls on targets etc., and in conjunction with the data change availability per asset. The scheduling engine is auto tunable to selectively define bandwidth per asset in order to reduce performance spikes to ensure a conformance with user service level objectives and minimize impacts on system RTOs.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 illustrates a computer network system that implements one or more embodiments of a backup system using supervised learning to implement dynamic data restore scheduling using data change metrics.

FIG. 2 is a block diagram illustrating an automatic restore scheduler component, under some embodiments.

FIG. 3 is a block and flow diagram illustrating operation of an automatic schedule and policy change component, under some embodiments.

FIG. 4 is a block diagram of a dynamic restore scheduler component using a data change metric and historic data, under some embodiments.

FIG. 5 is a flowchart that illustrates a method of dynamically modifying restore schedules using a data change rate measure, under some embodiments.

FIG. 6 illustrates a restore scheduling engine to mitigate spike activity for a Kubernetes-based cluster system, under some embodiments.

FIG. 7 illustrates a data chunking unit for use in a Kubernetes system, under some embodiments.

FIG. 8 shows a system block diagram of a computer system used to execute one or more software components of the present system described herein.

### DETAILED DESCRIPTION

A detailed description of one or more embodiments is provided below along with accompanying figures that illustrate the principles of the described embodiments. While aspects of the invention are described in conjunction with such embodiment(s), it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. In this specification, implementations, or any other form that the invention may take, may be referred to as techniques. In general, the order of the steps of disclosed processes may be altered within the scope of the invention.

Some embodiments of the invention certain computer network techniques deployment in a distributed system, such as a very large-scale wide area network (WAN), metropolitan area network (MAN), or cloud based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

Data protection systems involve backing up data at regular intervals for restoration, replication, or data move operations based on user need and/or data corruption events. To reduce the sheer amount of data that is backed up and stored, such systems typically use some form of deduplication to eliminate redundant copies of data, such as might be present with data that is frequently migrated, but not as frequently changed in between each backup period.

The Data Domain File System (DDFS) is an example of one such deduplication file system. As the data is ingested, the filesystem anchors and segments the data. The filesystem keeps track of segments which are stored on the disk, and if the segments were to be seen again, the filesystem would just store the reference to the original data segment which was written to disk. Deduplication backups often involve periodic full backups of backup clients by the backup server followed by one or more incremental backups that backup only that data that has changed from a last full backup. Because of the sheer number of backup clients and the amount of data in a large scale data processing system, such backups can be very time and processor intensive.

In order to provide appropriate backup protection to users, data protection vendors often implement certain service level agreements (SLAs) and/or service level objectives (SLOs) to define and quantify certain minimum requirements with regard to backup performance. These parameters usually define characteristics such as maximum backup time per session, minimum data throughput rates, maximum data restore times, data storage terms, and so on. The vendor and/or user is allowed to define policies that control backup operations, such as backup schedules, identity and priority of backup clients and storage targets, backup data types, and so on, and such policies are usually written so that the SLA and SLO requirements are met. However, the dynamic and changing nature of different clients and data types in a backup dataset means that these policies must be similarly adaptable and dynamic to accommodate such changes.

Data protection operations are usually controlled by policies that routinely perform backups according to defined schedules that specify which data assets are stored to specific storage targets and when. Changing data asset conditions, however, may interrupt usually scheduled backups, such as if a data source or asset experiences a significant change in data amounts or change rates. In this case, the backups may need to be modified to ensure that overall backup operations are not unduly affected. Embodiments include a data protection process that dynamically reschedules backups in the event of changes in data rates of assets being backed up and restored. The same parameters mentioned above may also be applied to data restoration operations as well as backups.

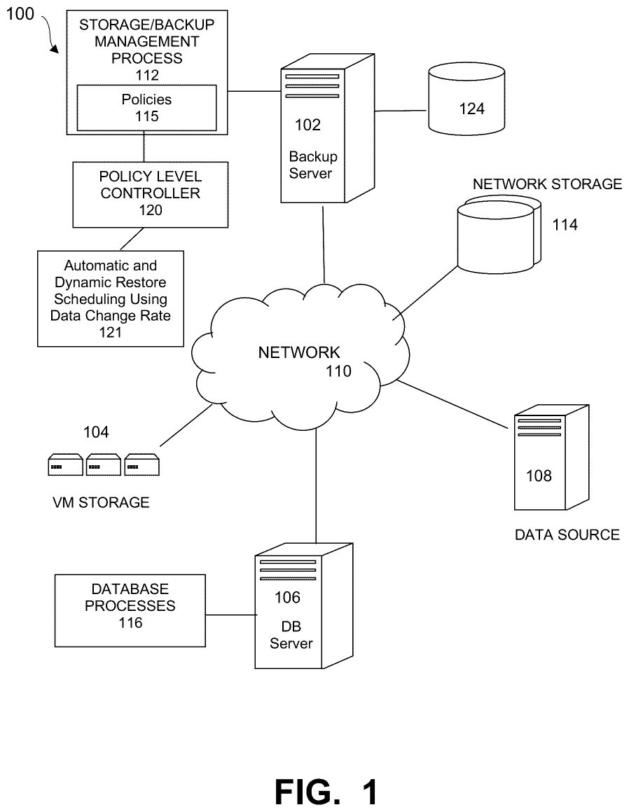

FIG. 1 illustrates a computer network system that implements one or more embodiments of a backup/restore system using data change metrics to dynamically adjust restore schedules and polices. In system 100 of FIG. 1, a storage server 102 executes a data storage or backup management process (or “backup program”) 112 that coordinates or manages the backup and restoration of data from one or more data sources 108 to storage devices, such as network storage 114, client storage, and/or virtual storage devices 104. With regard to virtual storage 104, any number of virtual machines (VMs) or groups of VMs (e.g., organized into virtual centers) may be provided to serve as backup/restore targets. The VMs or other network storage devices serve as target storage devices for data backed up or restored from one or more data sources, such as storage server 102 or data source 108, in the network environment. The data sourced by the data source may be any appropriate data, such as database data that is part of a database management system, and the data may reside on one or more hard drives for the database(s) in a variety of formats. Thus, a data source maybe a database server 106 executing one or more database processes 116, or it may be any other sources data for use by the resources of network 100.

The network server computers are coupled directly or indirectly to the data storage 114, target VMs 104, and the data sources and other resources through network 110, which is typically a cloud network (but may also be a LAN, WAN or other appropriate network). Network 110 provides connectivity to the various systems, components, and resources of system 100, and may be implemented using protocols such as Transmission Control Protocol (TCP) and/or Internet Protocol (IP), well known in the relevant arts. In a cloud computing environment, network 110 represents a network in which applications, servers and data are maintained and provided through a centralized cloud computing platform.

The data generated or sourced by system 100 and transmitted over network 110 may be stored in any number of persistent storage locations and devices. In a backup case, the backup process 112 causes or facilitates the backup of this data to other storage devices of the network, such as network storage 114. In an embodiment network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays, such as RAID (redundant array of individual disk) arrays. In an embodiment, system 100 may represent a Data Domain Restorer (DDR)-based deduplication storage system, and storage server 102 may be implemented as a DDR Deduplication Storage server provided by EMC Corporation. However, other similar backup and storage systems are also possible. In a data restore case, backed up data is migrated back from the storage devices to the original or other storage from which it was backed up.

As shown in FIG. 1, the backup management process 112 implements certain backup and restore policies 115. These policies are defined by the user or system administrator and specify various operational parameters of the backup/restore jobs. For example, policies dictate which data clients or data assets are backed to, or restored from, which storage targets, how often the backups and restores are made, and any special processing, such as encryption, and so on. Many different policies may be defined for the various data sources, assets, and storage targets in the system. For example, one policy may specify that critical or confidential data is stored frequently on high performance storage, such as solid state disk (SSD) or local hard disk drive (HDD) storage, while another policy may specify that routine or older data is stored periodically on cloud or archive tape storage, and so on.

Policies are usually written statically in terms of assigning certain data sources or assets to specific storage targets according to a set schedule based on an assumption that the type, amount, and change rate of such data remains approximately the same over multiple backup periods. That is, it is usually presumed that routine data is generated in a certain amount at a certain rate appropriate for periodic storage in long-term storage targets, and that critical data is typically of a lesser amount and can be stored more frequently in higher performance (and higher cost) storage devices. However, any significant change in data amounts and change rates may disrupt schedules, such as if a large amount of routine data is generated to the extent that it delays or interrupts its own or other schedules, such as if it consumes network bandwidth and prevents a backup or restore cycle for a critical dataset.

As described above, backups involve copying data from original locations (e.g., local or closely coupled storage) to secondary (e.g., mass network or cloud) storage, while restores involve moving backup data from the secondary storage back to the original (or new) storage locations. As in the case of backups, data restores can involve large amounts of data and sub-optimal restore schedules among different storage targets can cause huge performance spikes that negatively impact system performance and RTOs.

For purposes of description, the term “original” storage may mean any storage device from which data is copied, backed up, or restored from, and the term “target” storage may be any storage device to which data is copied. For example, for a backup operation, original storage may be local hard drive and target storage may be cloud storage, whereas for a restore, the original storage may be cloud storage and the target storage may be the local hard drive. However, the terms original and target generally mean a data source to a storage target depending on the direction of data migration, and regardless of operation (i.e., backup, restore, recovery, archive, migration, etc.).

Embodiments of system 100 include a policy level controller (PLC) 120 that manages storage targets (e.g., Data Domain appliances) and their attributes for best usage as storage resources. In an embodiment, the PLC 120 presents a storage resource as an usable unit to the storage management process 112, enabling it to define various operational parameters. These can include storage unit types, storage unit names, quotas, limits (hard/soft), authentication credentials, tokens, security, and so on. The PLC 120 can also interface to a user through a graphical user interface (GUI) to allow the user to explicitly associate storage resources to the devices controlled by the PLC. In this manner, the user can dictate that a particular set of assets use a precise set of storage to achieve certain protection goals.

As shown in FIG. 1, system 100 includes an automatic restore scheduler 121 that prioritizes, re-sizes, and/or reschedules data assets from the PLC for data transfer to the target storage to ensure that load at the target is balanced against spikes in demand from other data assets. The scheduler 121 does this by looking at the data change rates of the restore datasets generated by the restore clients using the backup server 102.

A ‘spike’ generally represents a sudden increase in demand for resource usage (e.g., CPU and/or memory) by one or more processes or applications in the system. Such a conditions may be measured relative to normal operations over time, and any increase by a defined amount within a relatively short period of time may be characterized as a spike. For example, for active data processing systems, any increase greater than 2% within a certain period of time may be characterized as a spike. Other percentage increases may also be used depending on system constraints and configurations.

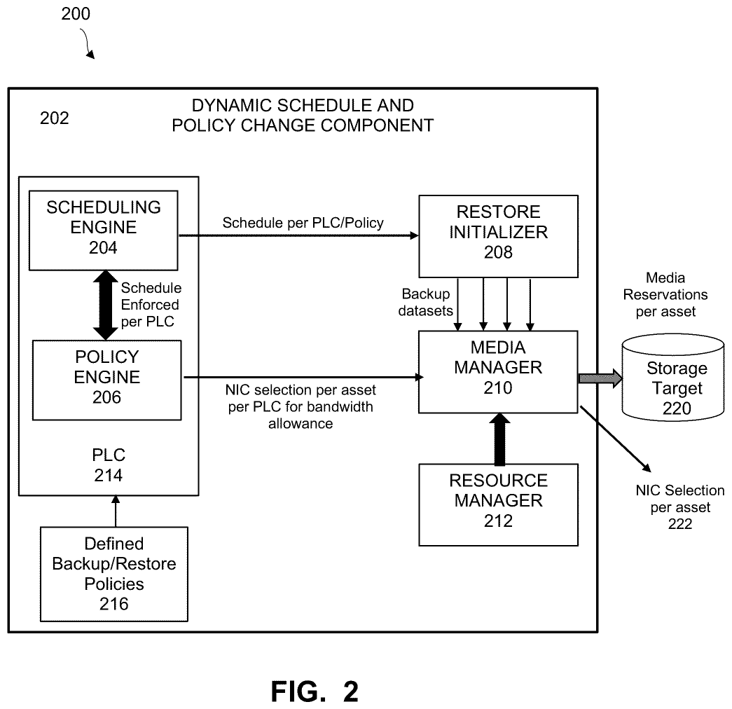

FIG. 2 is a block diagram illustrating an automatic restore scheduler component, under some embodiments. As shown in FIG. 2, system 200 includes an automatic schedule and policy change component 201 that has a PLC 214 that comprises a policy engine 206 and scheduling engine 204. Policy engine 206 processes policies as they are written by users or administrator, where policies dictate data restoration and/or backup schedules for various assets and appropriate target storage, along with any special handling instructions, such as encryption, access controls (e.g., RBAC), and so on. The policy engine 206 works with the scheduling engine to send restore jobs to a restore initializer 208. For the embodiment shown, defined policies are enforced by the PLC 214, and may consist of externally written policies or policies included in the PLC.

In general, PLC 214 acts as interactive interface to the user. Its policy engine 206 and scheduling engine 204 work in conjunction to facilitate the data protection for system 200. The scheduling engine 204 monitors and performs the job queuing from the assets included in the PLC. The scheduling engine tries to ensure a smooth allotment of restore jobs to the restore engine to get them serviced accordingly. The policy engine 206 records and processes the assets and their related details in relation to the assets in the PLC. For example, the policy engine would have the pool details, asset details, agent details, application assignments, and so on. The scheduling engine 204 has the jobs to be serviced per PLC, which could be discovery jobs from PLC, restore jobs from the PLC, deletion jobs from the PLC, and so on. The policy engine is the component that communicates the details to the scheduling engine from the PLC in an understandable format for scheduling.

The restore initializer 208 sends the restore datasets (assets) to a media manager 210, which is controlled by a resource manager 212, and reserves appropriate media storage for each asset. The resource manager 212 allocates network addresses and CPU resources for parallel processing streams. The network addresses typically comprise network interface device (NIC) port addresses, where a NIC is a hardware component that connects a device to the network. As stated above, the policy engine and scheduling engine work together to allocate the necessary resources for the triggered jobs. For example, the policy engine would be aware of the NIC and CPU availability for the PLC allocation, and the scheduling engine 204 would then handoff the relevant jobs with the NIC and CPU details to the next consecutive steps.

With a typical NIC interface architecture, the user could have multiple interfaces for backup and restores that are exclusively separate from the production networks, and these are serviced by different NIC ports or addresses. In this case, these NIC addresses are selected by the policy engine as per the user selection in the PLC. For example, a VM data type could have a NIC with 1 Gigabyte/second, whereas a file system data type might have a NIC with 2 Gbps. These two NIC's can then be selected for multiple similar form of assets. The PLC 214 thus sends a NIC selection per asset per PLC for bandwidth allowances to the media manager 210, and The media manager 210 then sends the restore data to the appropriate target 220.

In an embodiment, the scheduling engine 204, in conjunction with the policy engine 206 prioritizes only smaller datasets from the PLC 214 for the data transfer to the storage target device 220 in order to ensure the load at target is minimal until any additional data from other PLC's are serviced and any actual or potential spikes in data processing and storage reduced. The threshold size of the datasets defining datasets that are so transferred can be set by the system or user, and is selected based on one or more factors, such as average dataset size, data generation rates, network throughput, device speed/capacity, and so on. In present systems, typical example dataset sizes would be on the order of less than 1 GB of data, and the threshold would thus be selected per this size. Thus, smaller datasets comprise datasets that are of a size less than 1 GB. This is provided for illustration only, and other dataset sizes and threshold values can also be used.

For the data restoration embodiment of FIG. 2, the storage target 220 may be an original storage device from which the restored data was originally backed up from, such as a local hard drive receiving the restored data back from a storage location (not shown), or it may be a different storage device.

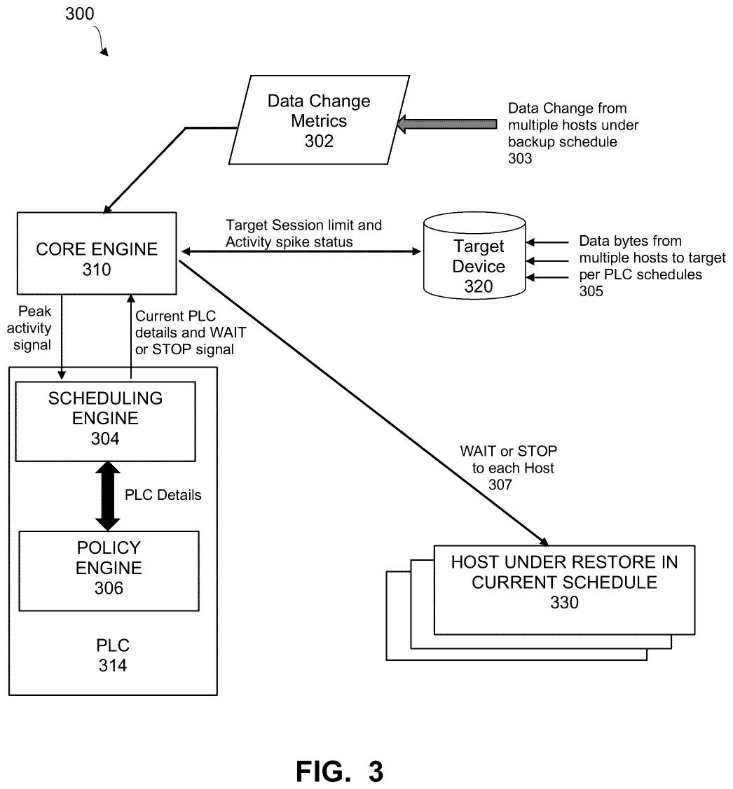

FIG. 3 is a block and flow diagram illustrating operation of an automatic schedule and policy change component, under some embodiments. As shown in FIG. 3, system 300 includes a number of hosts (restore clients) each generating data assets to be stored in storage target 320 during a current data restoration schedule. The hosts and their respective assets may exhibit different data change rates 303 that are quantified in respective data change metrics 302. The data change rate is expressed as a change in an amount of data (e.g., in bytes) per unit time (e.g., in seconds), and this rate may be scaled (e.g., kB/second) to any appropriate range based upon system configuration.

Policies dictating the data transfers from the restore hosts to the restore targets are defined by a PLC 314 through a policy engine 306 to the scheduler 304. The data restore operations are dynamically scheduled by this combination of components using data change rates for the assets and/or the hosts.

The data change metrics from the hosts are sent to a core engine 310, which generates a peak activity signal. The scheduling engine 304 fetches this peak activity signal from the core engine and uses this signal to send a WAIT or STOP signal to the job queue in the core engine 310. The WAIT or STOP signal can be triggered by monitoring the activity spike status and target session limit signals from the storage target 320 itself. The target may send a signal indicating that it has reached a limit for a restore session or that an overload condition is or is about to occur. This information is then associated with the currently serviced PLC details by the scheduling engine 304.

Overload conditions may be defined based on the configuration and operating conditions of the system, but generally include too much data, too many service requests for restore, too many restore jobs, or too many I/O operations trying to spike the CPU performance.

A WAIT or STOP signal thus indicates that the storage target 320 is being overloaded (i.e., generates a spike condition), so either the data transfer from the current PLC 314 should completely wait or only those data sets with the least data change should be transferred until the overload is reduced. This signal is passed to the host or hosts that need to suspend any current data transfer. The core engine 310 acts as a facilitator to route the appropriate signal calls 307 to the restore agent on each host in the instantaneous restore schedule ready to be initiated.

The storage target 320 then receives the data assets from the multiple hosts per the schedule as modified by the scheduling engine 310 and core engine 304 to limit the effect of any overload condition presented to the storage target 320.

The hosts or restore clients 330 in FIG. 3 may represent any type of computer or device generating different data objects at different times to be included in one or more data savesets. Such devices can range from computers, laptops, mobile devices, network devices, servers, and so on, all backing up data and metadata over network 100 through backup server 102 to various different storage systems 104, 114, 110, etc., using backup/restore program 112 and policies 115. Each client generally represents a device used by a user in a variety of different ways, such as for productivity (e.g., laptop/desktop computers), communications (e.g., mobile phones), applications (e.g., tablet computers), and so on. Other clients may include sensors, IoT (Internet of Things) devices, network interfaces, and other similar devices that generate data. Each client may thus generate different data that maybe subject to different protection policies based on data type, importance, volume, storage requirements, and so on.

In present systems, it is common for multiple busy restore clients to overload the target storage with data transfers from multiple PLC's. Such legacy restore agents would continue to send the additional datasets to the target device thus causing a spike in the target's workload, which could ultimately hamper the overall performance during data restores. Embodiments of system 300 address this issue by providing a degree of intelligence to the scheduler and core engine to reduce the workload by limiting further data transfers to the target device if there are multiple PLC's being serviced. In this way, if the target's load is high and/or the allowed session limit is neared or reached, further restores defined in the policy are temporarily suspended, rescheduled, or re-routed to eliminate target storage spikes.

In an embodiment that solves this problem, system 300 is configured to leverage the historic data from the previous policy and PLC information regarding the assets, time consumed for successful completion, space utilized on the target, and other similar factors. This historic data, in conjunction with the data change availability per asset, the scheduling engine can be modified to be auto tunable to selectively define certain policies per asset in order to ensure optimized restore operations with respect to properly utilized storage targets. This greatly improves existing schedulers that do not consider any sort of data change measure to tune themselves, but rather work purely on a manual override basis, thus preventing users from affecting certain policy changes at an asset level within a PLC for a specific period of time.

Historic data may show that data manageability overhead increases and redundant PLC related information is generated for a similar policy with similar assets. Hence, to mitigate the problems associated with such cases, information from the measured time window calculation and historic details of the assets and data change metric can be used by the dynamic scheduler process of system 300. For example, the scheduling engine 304 can be configured to automatically work with the policy engine 306 to assign a high bandwidth storage device to certain assets for a specific time period in order to increase the overall performance for the asset on a particular day so as to ensure the restore operations are well within the non-idle times of production host. Similar redirections of restore jobs or data assets within a restore job may also be performed, depending on system configuration and restore job compositions, sizes, and so on.

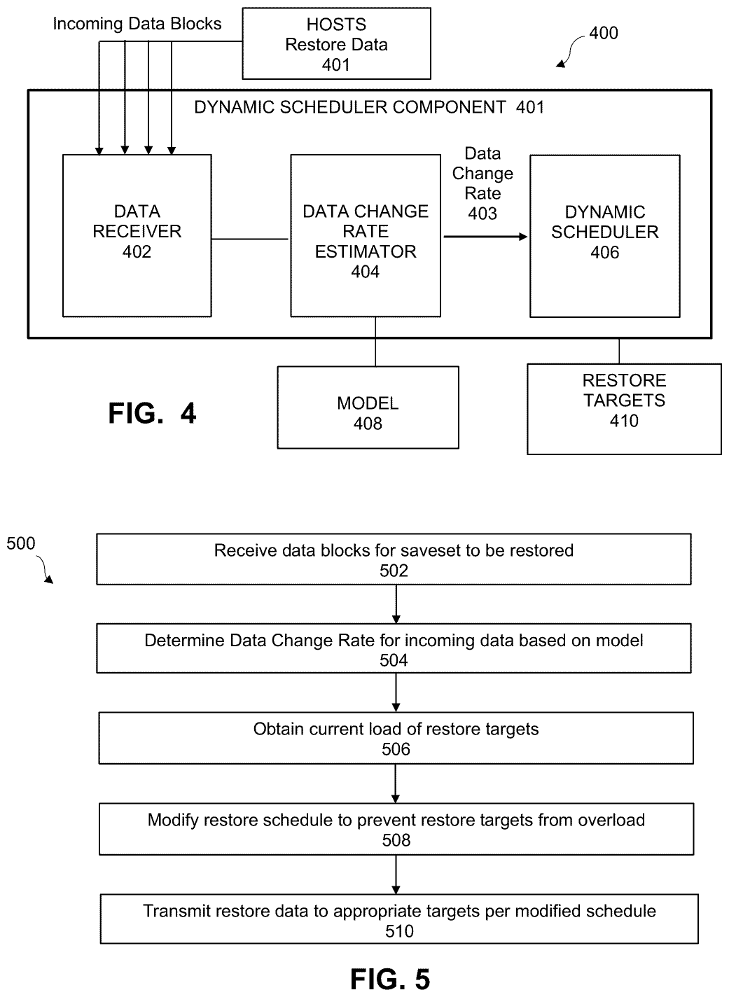

FIG. 4 is a block diagram of a dynamic restore scheduler component using a data change metric and historic data, under some embodiments. As shown in FIG. 4, system 400 includes a dynamic scheduler component 401 that modifies restore policies to change a time or destination of restore operations among restore targets 404.

A data receiver 402 is an interface component that receives incoming data blocks for data that is restored from one or more hosts 401. The incoming data blocks are analyzed by a data change rate estimator component 404 to determine a current rate of change as compared with historical data provided by a model 408.

In an embodiment, the estimator 404 is an analytical unit using a bit map that is created for the dataset being processed and which is compared with the bit map from the last incremental/full backup to detect the changes in the bit map of the dataset. For example, if there is a volume c:\ being replicated, a bitmap of the drive is fetched from the current time instant and compare it with historical data i.e., the bitmap from the last successful restore or a tuned time interval from the end user input, whichever is earlier. Also, along with the last bit map, any historical data changes from the present asset would be calculated using the model in place. With this comparison, the analytical unit would determine the data changes and parameter changes (e.g., size of changes, data change rate, etc.). The historical data provided by a model is a micro-unit of the estimator 404 that works as an AI-based analytical model to hold the historic bit map data of the data object under consideration. When a model 408 is referenced, it is the estimator in conjunction with the model that is holding the historic bit map data.

Any fitting AI algorithm to detect data changes from historic data or bit maps can be used for this embodiment. The estimation here is a quantifiable metric rather than a quality measure, and is done using the bit map of current time and bit map of the last successful restore in regular interval times historically. The analytical unit has an AI model that is trained with historic data to hold a proper bit map data change that could be potentially used as a reference to compare with the current bit map changes. The historical bit map data would inform only the reference for a bit map change comparison from the past data changes in the data unit.

In an embodiment, system 400 calculates the amount of data that has changed based on historic restore operations to determine a baseline restore cycle. For example, if an organization intends to restore data from a particular host to a particular target every hour, the system will calculate the average data change from previous restores and use that calculation to decide when the next restore cycle should occur.

In general, the estimator 404 does the work of data change estimation, and the system 400 makes the restore decisions regarding storage targets using the data change rates estimated. The estimator has a AI model 408 that is trained with historic data to hold a proper bit map data change that could be potentially used as a reference to compare with the current bit map changes. Historical bit map data would inform only the reference for a bit map change comparison from the past data changes in the data unit, and the estimator then takes care of the calculation.

Using the bitmap of the current time and the bitmap of the last successful restore made during regular time intervals, the estimator component 404 calculates a data change rate metric 403, which is a quantifiable value rather than a qualitative characteristic. This metric is then passed to a dynamic scheduler component 406. For the data change rate, this metric is expressed as a number of bytes changed per unit time (bytes/time), where the time period may be configured based on system configuration and needs. For example, if the data change rate calculation shows that there was a data change of 100 GB per hour, then the data change rate metric 403 would be 100 GB, regardless of when the last restore occurred. This metric is dynamic and may change depending on the organization's data load.

The data change rate metric 403 is provided to a dynamic scheduler 406 that modifies one or more PLC policies that dictate when and how much data is sent to the restore target or targets 410. If it appears that the amount or rate of data sent by the current policy will cause a spike or overload in a data target, the scheduler will effectively modify the policy by delaying or postponing the restore operation, or rerouting the data to a different restore target.

The threshold value or range defining an overload condition may be set by the system, target storage device, or a user depending system configuration and restore operations. These values along with re-scheduling and/or re-routing rules can be stored in a database accessible to the dynamic scheduler 406.

For the embodiment shown in FIG. 4, system 400 makes use of use of historical data from users that train a model 408 to decide the optimum scheduling and targets of restore jobs for datasets from hosts 401. This system makes use of the historical data from the user environments (or laboratory scenarios) to reduce data transmission load to the potentially overloaded targets. The historic bit map is generally accurate and can give a fair idea of the data change estimations, which is then used by the estimator 404 and dynamic scheduler 406 to ultimately select the best restore schedule for the targets, as based on the data change rate of the data savesets. The best schedule is the one prevents overloading of any of the target storage devices 410.

As described, the appropriate restore schedule is chosen using a metric embodying the rate of data change of a dataset (or data asset) processed by the restore system 100. The rate of data change of a saveset is measured to drive a metric referred to herein as a “data change measure” or “data change metric.” FIG. 5 is a flowchart that illustrates a method of dynamically modifying a restore schedule using a data change rate measure, under some embodiments. As shown in FIG. 5, process 500 starts in step 502 with the receiving of data blocks for data savesets to be restored. The data may be any appropriate data elements, such as a virtual machine, filesystem, database, document, and so on.

In step 504, the actual data change rate of the incoming data is determined. Alternatively, or in addition, an estimated data change rate from estimator component 404 uses a model 408 can be used to calculate the data change rate 403 of the incoming data. As described above, the model uses a complete or near-complete history of changes to the dataset and derives a bit map change metric as a reference for comparison and estimation. This can provide a better estimation than a straight calculation of data change rate for the present data set, which would only use the current and last bitmap from a last restore.

In step 506, a current load condition of the restore target is obtained, such as through a target session limit or activity spike status signal, as shown in FIG. 3. Based on this load information and the data change rate, the dynamic rescheduler can modify a current restore policy to delay or postpone a current restore session, 508. It may also re-route the data saveset to an alternate storage target. The system can then transmit the restore data to the appropriate targets per the dynamically modified restore schedule.

### Modified Scheduling Engine for Spike Reduction in Kubernetes Workloads

In an embodiment, the PLC 314 is further configured to leverage the historic data from the previous policy/PLC information regarding the assets, time consumed for successful data transfers, bandwidth utilized for calls on targets etc., and in conjunction with the data change availability per asset. The scheduling engine is auto-tunable to selectively define bandwidth per asset in order to reduce performance spikes to ensure a conformance with user service level objectives.

Many distributed or cluster networks having many source and target storage nodes utilize the Kubernetes containerized architecture. In Kubernetes, a pod is the smallest execution unit and can encapsulate one or more applications. A pod holds a container, and a container is an image of a particular application. In the context of managing Kubernetes workloads and mitigating performance spikes, it should be noted that pods play a fundamental role within the containerized architecture. Acting as the smallest unit of execution, pods encapsulate one or more applications within containers, thus forming the building blocks of distributed or clustered networks. However, when tasks like pod or namespace restoration are initiated, the risk of performance spikes is significant.

Conventional approaches often lack the sophistication to consider the intricate performance dynamics of individual assets, relying instead on static availability metrics. This oversight can lead to unsupervised restores that strain system resources and disrupt overall cluster performance. To address this challenge effectively, a modified scheduling engine, informed by historical data and performance insights, becomes indispensable. By analyzing past transfer times, bandwidth utilization, and asset-specific requirements, this adaptive engine, as described herein, can dynamically allocate resources to restoration operations. Such an intelligent approach ensures that restoration processes proceed smoothly without causing detrimental spikes in performance. By fine-tuning resource allocation based on real-time needs and historical patterns, the scheduling engine optimizes workload management, minimizes the risk of production downtime, and maximizes the efficiency of the scheduling window.

As just mentioned, in a Kubernetes deployment comprising several pods and namespaces, restoring a pod or namespace without incurring a spike on the namespace is imperative because any hindrance of the overall pods' performance due to the spike could lead to a total shutdown of the pods. Present cluster systems do not consider the performance levels on the target host, but instead only check for a static availability on the namespace or the pod to perform the restore operations. In this case, a large number of workloads due to unsupervised restores leads to a good chance of restore spiking on the host and stalling the production itself, or needing to pause the restore workflow, thus increasing the schedule window.

In an embodiment, the cluster system includes a system and method for polling the spike performance on the host and utilizes the data chunking depending upon the pod attributes in order to ensure that the priority pod data is transferred in regular data chunks that do not disrupt the machine and ensure a smooth restore operation despite the spike in performance on the host.

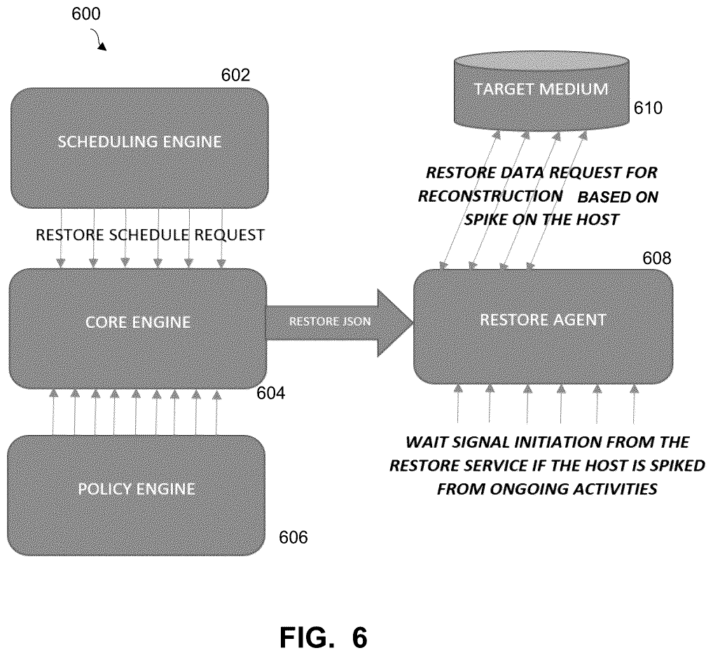

FIG. 6 illustrates a restore scheduling engine to mitigate spike activity for a Kubernetes-based cluster system, under some embodiments. As shown in FIG. 6, system 600 includes a scheduling engine 602 that sends restore schedule requests to a core engine 604, which applies policies from policy engine 606 to send restore instructions to restore agent(s) 608.

If the host is undergoing a spike condition that restricts its ongoing activities, it sends a wait signal to the restore agents. The restore agents recognize any wait signal received from the host and make a restore data request to the target medium 610 based on the wait signal initiated by the host. In prior systems, these restore requests would be executed regardless of the spike condition on the host, thus causing disruption in the system.

To mitigate spike conditions in the Kubernetes cluster environment, all of the dependent data is chunked from the target device and is transferred to the respective pods from the restore agent and is simply buffered without the reconstruction. Data chunking depends entirely upon the available CPU at the instant or any activities waiting from the production network. NIC selection from the scheduling engine works in conjunction to provide the best available restore network assigned by the administrator.

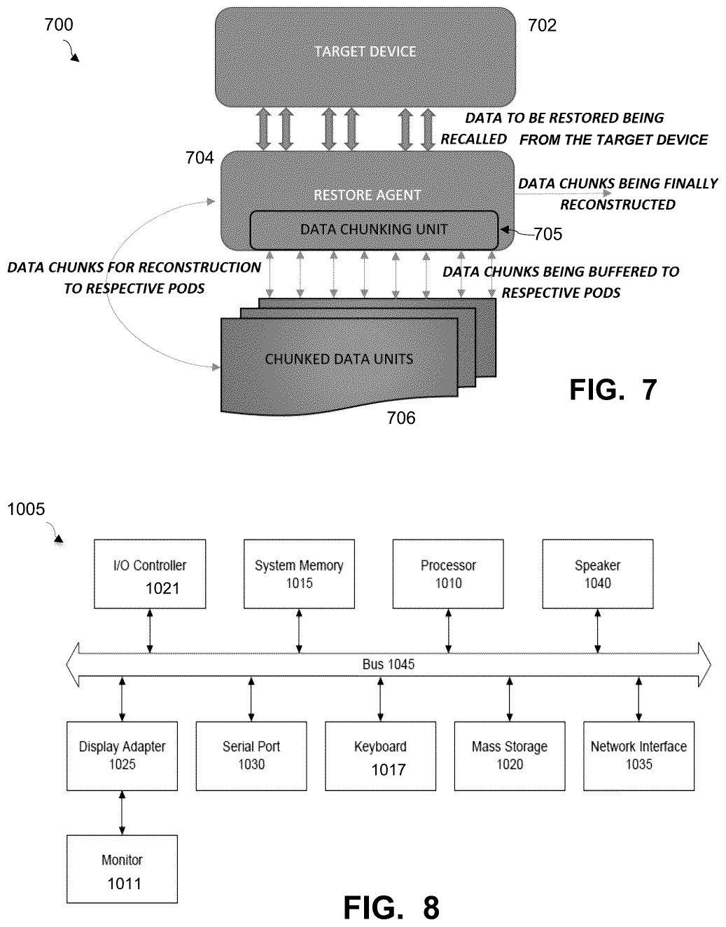

FIG. 7 illustrates a data chunking unit for use in a Kubernetes system, under some embodiments. As shown in FIG. 7, system 700 comprises a target device 702 having a restore agent 704 with a data chunking unit 705. The data chunking unit 705 creates chunked data units 706. In system 700, the data is chunked into small sizes and moved by the restore agent 704 and buffered in the respective pod or namespace for later reconstruction. Once the host's spike condition is reduced, the final reconstruction would be initiated on the respective pod or host in the namespace and the restore operation is then finished. In this manner, the spike condition is mitigated before the data restore operation is executed to minimize any negative impact of the spike in the system with respect to the data restores.

The system of FIG. 1 may comprise any number of computers or computing devices in client-server networks including virtual machines coupled over the Internet or similar large-scale network or portion thereof. Each processing device in the network may comprise a computing device capable of executing software code to perform the processing steps described herein. FIG. 8 is a system block diagram of a computer system used to execute one or more software components of the present system described herein. The computer system 1005 includes a monitor 1011, keyboard 1017, and mass storage devices 1020. Computer system 1005 further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1005. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1005 is but an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

An operating system for the system may be one of the Microsoft Windows®. family of systems (e.g., Windows Server), Linux, Mac OS X, IRIX32, or IRIX64. Other operating systems may be used.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11x), near field communication (NFC), radio-frequency identification (RFID), mobile or cellular wireless. For example, signals from a computer may be transferred, at least in part, wirelessly to components or other computers.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method of dynamically scheduling restore jobs in a data protection system, the method comprising:
receiving data from one or more restore clients for restoration of data from a storage target in accordance with a defined restore policy;
determining a data change rate of the data, as expressed as a number of bytes changed per unit of time;
receiving, from the storage target, an indication of a current load condition of the storage target; and
modifying, if the current load condition exceeds a threshold value, the restore policy to delay or redirect the transmission of restore data to the storage target to prevent an overload of the storage target.

2. The method of claim 1 wherein the restore policy dictates datasets, restore clients, storage targets, special handling requirements, data processing operations, and storage parameters for the restore jobs.

3. The method of claim 1 wherein the overload condition comprises at least one of: an amount of data transmitted to the storage target in excess of its storage capacity, transmission of data at an excessive rate compared to an ingress rate of the storage target, or an excessive number of input/output operations to the storage target.

4. The method of claim 1 wherein the policy is generated by a policy level controller (PLC) that manages storage targets and their attributes for best usage as storage resources in the system, and defines various operational parameters.

5. The method of claim 4 wherein the operational parameters are selected from the group consisting of: storage unit types, storage unit names, quotas, limits (hard/soft), authentication credentials, tokens, and security mechanisms.

6. The method of claim 5 wherein the PLC communicates with a scheduling engine to control a core engine that provides wait or stop signals to the restore client to delay or suspend the transmission of the restore data.

7. The method of claim 6 wherein the indication from the storage target comprises at least one of a target session limit signal, or an activity spike status signal of the storage target.

8. The method of claim 1 wherein the redirect comprises a change of storage target to a different storage target not presently prone to the overload condition, or that comprises a higher performance or higher availability storage device.

9. The method of claim 6 further comprising training a model using historical data of restore operations of the saveset to establish past data change metrics for corresponding restore operations involving the restore client and the storage target.

10. The method of claim 1 wherein the network comprises a PowerProtect Data Domain deduplication backup system.

11. The method of claim 10 wherein the network comprises a Kubernetes-based cluster network running containerized applications to generate the restore data.

12. A system for dynamically scheduling restore jobs in a data protection network, comprising:
a hardware-based policy level controller coordinating a scheduling engine and policy engine implementing a policy to restore data from one or more restore clients for storage on a storage target;
a component determining a data change rate of the restore data in a current restore session;
a processor-based core engine functionally coupled to the scheduling engine and using the data change rate of the restore data to dynamically redefine the policy in response to the data change rate and a current load of the storage target.

13. The system of claim 12 wherein the restore policy dictates datasets, restore clients, storage targets, special handling requirements, data processing operations, and storage parameters for the restore jobs.

14. The system of claim 13 wherein the overload condition comprises at least one of: an amount of data transmitted to the storage target in excess of its storage capacity, or transmission of data at an excessive rate compared to an ingress rate of the storage target, and wherein the core engine redefines the policy by at least one of re-scheduling the current restore session or directing the data transmitted in the current restore session to a different storage target.

15. The system of claim 12 wherein the PLC manages storage targets and their attributes for best usage as storage resources in the system, and defines various operational parameters selected from the group consisting of: storage unit types, storage unit names, quotas, limits (hard/soft), authentication credentials, tokens, and security mechanisms.

16. The system of claim 15 wherein the core engine receives the current load of the storage target by at least one of a target session limit signal, or an activity spike status signal of the storage target, and further comprising a supervised learning model trained using historical data of restore operations of the saveset to establish past data change metrics for corresponding restore operations involving the restore client and the storage target.

17. A method of dynamically scheduling a restore job in a Kubernetes-based cluster network, comprising:
deploying a restore agent functionally coupled to a target device and having a data chunking unit;
chunking, in response to a spike condition in the cluster network, restore data into a plurality of small chunks relative to an overall size of the restore data;
buffering the chunked restore data in respective pods of the cluster network; and
reconstructing, after reduction of the spike condition, the chunked restore data on the respective pods to complete the scheduled restore job.

18. The method of claim 17 wherein the data is chunked based on an available amount of CPU resources at a particular time.

19. The method of claim 18 further comprising selecting a controller within the cluster network by a scheduling engine works to provide a best available restore network for the restore job.

20. The method of claim 19 wherein the spike condition comprises at least one of: an amount of data transmitted to the target device in excess of its storage capacity, or transmission of data at an excessive rate compared to an ingress rate of the target device.
